(19) United States
(12) Patent Application Publication
(10) Pub. No.: US 2023/0098634 A1
(43) Pub. Date: Mar. 30, 2023

(54) RIGHT-ANGLED ORTHOGONAL CONNECTOR ASSEMBLY HAVING A WIRE TERMINATION TO A HIGH-SPEED CABLE

(71) Applicant: Lenovo Global Technology (United States) Inc., Morrisville, NC (US)

(72) Inventors: Jonathan Hinkle, Raleigh, NC (US); Andrew Junkins, Cary, NC (US); Tony C Sass, Fuquay Varina, NC (US)

(21) Appl. No.: 17/490,262

(22) Filed: Sep. 30, 2021

(51) Int. Cl. H01R 12/72; G06F 13/42

(52) U.S. Cl. CPC H01R 12/724; G06F 13/4221; G06F 2213/0026

(57) ABSTRACT

An apparatus or hybrid connector includes a connector assembly and a plurality of electronically conductive elements supported by the connector assembly. The connector assembly further includes a first connector for connecting with a first printed circuit board (PCB), a second connector for connecting with a second PCB, and a wire termination connected to a high-speed communication cable. The second connector forms a right angle with the first connector, and the second connector is oriented to connect with the second PCB in an orthogonal orientation to the first PCB. The conductive elements have a first end terminating in the second card edge connector, whereas a first portion of the conductive elements have a second end terminating in the wire termination and a second portion of the conductive elements have a second end terminating in the first connector. Multiple hybrid connectors may be connected to a first printed circuit board.

### BACKGROUND

The present disclosure relates to connectors carrying high-speed signals between components in a computing system.

### BACKGROUND OF THE RELATED ART

The speed of communications between components within a computing system have been increasing rapidly. The interfaces, such as Peripheral Component Interconnect Express (PCIe), typically run at signal frequencies of about 16-64 gigabits per second (Gbps). Maintaining signal integrity of these interfaces at such high frequencies is a challenge. For example, these high-speed interconnects may require specially designed interconnects that use expensive low-loss interconnect materials and may be limited in interconnect length, or may require the addition of signal repeaters or retimers which add cost and power consumption to systems. However, even if the signal integrity of the high-speed signals can be maintained to a system backplane that interfaces with multiple device cards, the signals must still travel through the system backplane board and additional connectors before reaching a pluggable device card. The backplane itself and each of the necessary device connectors can further contribute to a reduction in signal integrity. While a vertical backplane takes up less space in system depth, they are typically expensive boards and can significantly impair system cooling. A horizontal backplane may improve system cooling relative to a vertical backplane and may enable a greater density of devices supported in a computing system, but the length of the high-speed interconnect may still be long and will continue to challenge signal integrity.

### BRIEF SUMMARY

Some embodiments provide an apparatus comprising a connector assembly. The connector assembly includes a first card edge connector for connecting with a first printed circuit board, a second card edge connector for connecting with a second printed circuit board, and a wire termination connected to a first end of a high-speed communication cable. The second card edge connector forms a right angle with the first card edge connector, and the second card edge connector is oriented to connect with the second printed circuit board in an orthogonal orientation to the first printed circuit board. A plurality of electronically conductive elements are supported by the connector assembly and have a first end terminating in the second card edge connector. A first portion of the plurality of electronically conductive elements have a second end terminating in the wire termination, and a second portion of the plurality of electronically conductive elements have a second end terminating in the first card edge connector.

Some embodiments provide an apparatus comprising a first printed circuit board and a plurality of connector assemblies. Each connector assembly includes a first card edge connector connected to the first printed circuit board along an edge of the first printed circuit board, a card edge socket for connecting with a device card, and a wire termination connected to a high-speed communication cable. The card edge socket forms a right angle with the first card edge connector and is oriented to connect with the device card in an orthogonal orientation to the first printed circuit board. Each connector assembly includes a plurality of electronically conductive elements that are supported by the connector assembly and have a first end terminating in the second card edge connector. For each connector assembly, a first portion of the plurality of electronically conductive elements have a second end terminating in the wire termination, and a second portion of the plurality of electronically conductive elements have a second end terminating in the first card edge connector.

### BRIEF DESCRIPTION OF THE SEVERAL VIEWS OF THE DRAWINGS

FIG. 1 is a side view of a connector assembly installed on a horizontal printed circuit board to support communication with a pluggable printed circuit board.

FIG. 2 is a top view of the horizontal printed circuit board having multiple connector assemblies.

FIG. 3A is a perspective view of a connector assembly having a lead frame with compliant pins for coupling to the horizontal printed circuit board.

FIG. 3B is a perspective view of a connector assembly including a paddle card with a card edge connector receiving in a card edge socket connector secured on the horizontal printed circuit board.

FIG. 4A is a perspective view of a high-speed cable for direct connection to the connector assembly.

FIG. 4B is a diagram of a high-speed cable including a plurality of twin-axial lanes.

FIG. 5 is a side view of a pluggable printed circuit board that may be connected to the card edge socket connector of the connector assembly.

FIG. 6 is a schematic diagram of a connector assembly including the having high-speed conductive elements that terminate in a connector.

FIG. 7 is a diagram of a wire termination formed between a flex circuit and a connector assembly.

### DETAILED DESCRIPTION

Some embodiments provide an apparatus comprising a connector assembly. The connector assembly includes a first card edge connector for connecting with a first printed circuit board, a second card edge connector for connecting with a second printed circuit board, and a wire termination connected to a first end of a high-speed communication cable. The second card edge connector forms a right angle with the first card edge connector, and the second card edge connector is oriented to connect with the second printed circuit board in an orthogonal orientation to the first printed circuit board. A plurality of electronically conductive elements are supported by the connector assembly and have a first end terminating in the second card edge connector. A first portion of the plurality of electronically conductive elements have a second end terminating in the wire termination, and a second portion of the plurality of electronically conductive elements have a second end terminating in the first card edge connector.

In some embodiments, the first portion of the plurality of electronically conductive elements carry high-speed signals and the second portion of the plurality of electronically conductive elements carry low-speed signals and electrical power. For example, the first portion of the plurality of electronically conductive elements may include all of the lanes of a serial computer expansion bus, such as a serial computer expansion bus that supports communication using the Peripheral Component Interconnect Express (PCIe) standard. Optionally, the second portion of the plurality of electronically conductive elements may include an Inter Integrated Circuit (I2C) bus for carrying the low-speed signals. In a further option, the low-speed signals may be sideband signals selected from interrupts, power-management requests and/or reset commands. Embodiments of the apparatus that include three terminations or connectors may be referred to as a connector assembly or a hybrid connector, since a first portion of the conductive elements extend from the second card edge connector to the high-speed communication cable to carry high-speed signals and a second portion of the conductive elements extend from the second card edge connector to the first card edge connector to carry other signals and power.

In some embodiments, the second card edge connector is a card edge socket for connecting with card edge fingers of the second printed circuit board. The second printed circuit board may implement any of a wide variety of functionality, such as a graphics processing unit, non-volatile memory, network adapter, and other functions now in existence or developed in the future.

In some embodiments, the first card edge connector may include a direct lead frame attached to the first printed circuit board. For example, the lead frame may include compliant pins for connecting to plated through-holes in the first printed circuit board or may include surface mount leads for soldering to the pads on the first printed circuit boards. In some embodiments, the connector assembly may include a paddle card and the first card edge connector may include card edge fingers that are pluggable into a vertical card edge socket mounted on the first printed circuit board.

In some embodiments, the high-speed communication cable may include at least 16 wires, and the connector assembly may include at least 16 conductive elements extending from the wire termination to the second card edge connector. In one option, the high-speed communication cable may be a twin-axial, shielded cable. In another option, the high-speed communication cable may be a flex circuit. For example, a flex circuit, flexible printed circuit or flexible electronics include electronic circuits on a flexible plastic substrate, such as polyimide, polyether ether ketone (PEEK) or transparent conductive polyester. Still further, the high-speed communication cable may be capable of supporting up to 112 Gbps signaling. In some embodiments, the first printed circuit board may be a backplane, and a second end of the high-speed communication cable may be connected to a serial computer expansion bus on a motherboard or other device card.

Some embodiments provide an apparatus comprising a first printed circuit board and a plurality of connector assemblies. Each connector assembly includes a first card edge connector connected to the first printed circuit board along an edge of the first printed circuit board, a card edge socket for connecting with a device card, and a wire termination connected to a high-speed communication cable. The card edge socket forms a right angle with the first card edge connector and is oriented to connect with the device card in an orthogonal orientation to the first printed circuit board. Each connector assembly includes a plurality of electronically conductive elements that are supported by the connector assembly and have a first end terminating in the card edge socket. For each connector assembly, a first portion of the plurality of electronically conductive elements have a second end terminating in the wire termination, and a second portion of the plurality of electronically conductive elements have a second end terminating in the first card edge connector. Optionally, the first printed circuit board may be a horizontal backplane.

In embodiments of the apparatus having a plurality of the connector assemblies connected to the first printed circuit board, the first portion of the plurality of electronically conductive elements for each connector assembly may include all of the lanes of a serial computer expansion bus to carry high-speed signals, and the second portion of the plurality of electronically conductive elements for each connector assembly may include an Inter Integrated Circuit bus to carry low-speed signals and conductive elements to carry electrical power. For embodiments of the apparatus that have a plurality of connector assemblies connected to the first printed circuit board, any or all of the connector assemblies, connectors and/or cables may include any one or more features or structures described herein in reference to a connector assembly, connector and/or cables that may be used in connection to a printed circuit board.

Some embodiments of the connector assembly or hybrid connector may be used in conjunction with a horizontal printed circuit board, such as a backplane. A backplane may include electrical connectors in parallel with each other to form a computer bus as to one or more signals. Power and ground planes may also be included in the horizontal printed circuit board. A midplane is one type of backplane that has connectors on both sides of the printed circuit board. The horizontal printed circuit board may connect to a motherboard, also referred to as a system board, via one or more board-to-board connections that support communication between the motherboard and the horizontal printed circuit board. Suitable board-to-board connections may include connectors and/or cables.

In some embodiments, the horizontal printed circuit board may be a simple, low-layer count printed circuit board, such as a 4-layer printed circuit board made with inexpensive materials that are suitable for low-speed signals. Since the high-speed signals are running through a separate high-speed cable to the connector assembly rather than through the horizontal printed circuit board, the horizontal printed circuit board does not require, and may be free from, any dense routing of impedance-controlled, high-speed signals. Therefore, the horizontal printed circuit board does not require a high number of layers and/or more expensive materials to support impedance-controlled, high-speed signals. By contrast, the system motherboard may have from 8 to 12 layers and a device backplane that accommodates high-speed connections may be very thick and include up to 16+ layers. Accordingly, it should be appreciated that the hybrid connector system eliminates any requirement of a high-speed backplane for pluggable devices.

Some embodiments of the connector assembly or hybrid connector may connect to low-speed signals on the horizontal printed circuit board. For example, the low-speed signals may be provided in a bus, such as an Inter-Integrated Circuit (“I2C”) bus or a System Management Bus (“SMBus”). An I2C bus is a synchronous, multi-master, packet switched, single-ended, serial communication bus. A System Management Bus is a single-ended, two-wire bus for lightweight communication, such as the communication of ON/OFF instructions or signal (power disable; PWRDIS) with a power source. The low-speed signals, as well as others not mentioned, may be wired from a motherboard to a horizontal printed circuit board, but conductive traces on or in the horizontal printed circuit board may connect those signals to several or all of the connector assemblies or hybrid connectors that are installed on the horizontal printed circuit board. Non-limiting examples of the low-speed signals may include presence detect, LED blink or activity signals, and single function pins like power state control. These slower signals do not all pass through PCIe bus and some are not routed with the PCIe connection. For example, the PCIe connection may come directly from the CPU on the motherboard, but an I2C connection may come from the baseboard management controller (BMC), which is a separate small microcontroller that performs system management. The sideband signals may be run from the system motherboard through a bundle of wires or ribbon cable (just wires in rubber or plastic) and to a connector on the horizontal backplane.

Some embodiments of the connector assembly or hybrid connector may connect to power on a horizontal printed circuit board, such as a backplane. For example, the horizontal printed circuit board may include one or more power planes, such as a +12V plane and a ground plane, that may be connected to the hybrid connector and provided to the pluggable device. Furthermore, the horizontal printed circuit board may receive power from the system board or directly from a power supply through larger, thicker wires to one or two connectors on the horizontal backplane.

Some embodiments of the connector assembly or hybrid connector may be permanently connected to the horizontal printed circuit board. For example, the hybrid connector may include a lead frame that is connected to the horizontal printed circuit board by compliant pins, surface mount, solder tail, or any other pin connections.

Some embodiments of the connector assembly or hybrid connector may be selectively pluggable, such that the hybrid connector may be insertable or removeable from a separate connector on the horizontal printed circuit board, such as a card edge socket connector. For example, the hybrid connector may include a paddle card (printed circuit board) having conductive pads or fingers that are received into the socket to form an electronic connection between individual conductive traces in the horizontal printed circuit board and individual conductive traces in the paddle card.

In some embodiments, the high-speed signals are transmitted through conductive circuits with controlled electrical impedance to prevent the signal from reflecting from impedance discontinuities or other disruptions. Accordingly, the high-speed conductive circuits, such as the cables, connectors and/or conductive traces, are preferably designed for lower loss than are the low-speed circuits. The high-speed conductive circuits may also have a higher density of interconnections. In contrast, the power circuits for delivering power at a certain voltage are typically large and bulky to have lower electrical resistance and the low-speed signals are not very susceptible to impedance changes such that most circuit connections are suitable. Non-limiting examples of the high-speed signals include Peripheral Component Interconnect Express (PCIe) and clock.

Some embodiments of the connector assembly or hybrid connector include a high-speed termination to a high-speed cable, such as a twin-axial cable. The high-speed cable may include a plurality of conductor pairs, where each pair is able to support differential signaling. In high-speed signaling, the electrical signals switch fast enough that signal integrity is affected by conductor characteristics, such as the electrical impedance, and physical interconnect construction, such as the type and number of connections between a signal source and a signal destination. Accordingly, embodiments of the connector assembly provide a high-speed termination so that a high-speed cable may be connected from a signal source directly to the connector assembly. The connector assembly may then transfer the signals to any expansion card that is plugged into the card edge socket of the connector assembly. It should be appreciated that the direct connection with the high-speed cable may avoid one or more physical interconnects that may degrade signal integrity, may reduce the physical distance that the signals must travel, and may reduce the complexity of the horizontal printed circuit board to which the connector assembly is connected. The complexity of the horizontal printed circuit board may be reduced since the high-speed signal bypass the horizontal printed circuit board so that there is no need to include a high-speed bus within the printed circuit board.

In some embodiments, the high-speed cable termination on the connector assembly may form a pluggable connection. For example, a card edge socket connector may be secured to the connector assembly and may have conductive pins for each wire in the cable. Accordingly, one or both ends of the high-speed cable may include a small paddle card (printed circuit board) forming conductive pads or fingers to which each wire of the high-speed cable is independently soldered. The cable paddle card may then be plugged into the card edge socket connector on the connector assembly to form a connection there between. Optionally, the card edge socket connector for the high-speed cable may form a socket that is secured to one side of the connector assembly and may be perpendicular, angled, or parallel to the connector assembly. A right-angle socket connector may allow the high-speed cable to be connectable to the socket with less space between adjacent connector assemblies and with less interference with airflow between the connectorassemblies.

In some embodiments, the high-speed cable termination on the connector assembly may be a permanent connection. For example, each wire in the high-speed cable may be soldered directly to a separate one of a plurality of pads formed on the connector assembly. Each pad may be connected to a conductive trace or other conductive element that extends to a card edge connector socket where the conductive trace or other conductive element is connected to a pin in the card edge connector socket. Optionally, the pins may be on one or both sides of the socket for connection with card edge connector pads or fingers on one or both sides of a pluggable card when the pluggable card is received into the socket.

In some embodiments, the high-speed cable may include a plurality of differential pairs of wires, such as are used in serial communications. The differential pairs of wires may be separately formed and encased in an electrically insulating material. Each of the separately formed differential pairs of wires may be independent of any other differential pairs of wires or may be coupled together to form a ribbon cable or similar configuration. In one option, the high-speed cable or cables may be bent or folded to follow a configuration that follows a desired route between two connectors and may have sufficient plasticity to retain the bent or folded configuration. For example, the high-speed cable may be bent or folded to minimize airflow resistance, disturbance or redirection through a chassis that houses the printed circuit boards, connector assembly, cables and other components of the computer system. Specifically, if the high-speed cable is a ribbon cable or otherwise has a narrow dimension and a wide dimension, the interference with airflow may be minimized by bending or folding the cable so that the narrow dimension faces into the direction of airflow and the wide dimension extends along the direction airflow. Any number and type of folds may be used to accomplish a desired cable configuration. It is possible to bend or fold a cable to minimize airflow interference independent of the orientation or placement of the cable connector on the hybrid connector.

In some embodiments, the differential pair of wires in the high-speed cable may be provided by a twin-ax cable (also referred to as “twinaxial” cable or simply “twinax”). A twin-axial cable includes two inner conductors surrounded by a conducting shield, where the two inner conductors and conducting shield are each isolated from the other by a dielectric (electrically insulating) material. The two inner conductors are coupled electromagnetically to each other as standard for a differential pair and are impedance controlled, typically by shielding or some type of ground wires. In other embodiments, the high-speed cable may be or include one or more single-ended cables rather than having differential pairs. Any type of impedance-controlled high-speed cable could be used. One example of a high-speed, single-ended cable is a coaxial cable.

In some embodiments, the high-speed cable may be designed to carry a single lane, but the high-speed cable may also be designed to carry multiple lanes. A high-speed cable or cables that provide multiple lanes may take various forms, such as a wide cable (sometimes referred to as a “ribbon cable”) or a cluster of twinax cables. For example, one high-speed cable may have at least 16 wires including 8 differential pairs, which communicate unidirectionally in two different directions to provide 4-lanes (4x) in each direction (transmit and receive on both ends). In one option, the high-speed cable may have at least four (4) lanes. In some embodiments, the apparatus or hybrid connector will provide full support for communications accordingly to a serial computer expansion bus standard, such as the Peripheral Component Interconnect Express (PCIe) standard.

Some embodiments of the apparatus or assembly may provide a computing system with the technical benefit of accommodating a high-performance card or device that in insertable and removable from the computing system. Specifically, embodiments of the apparatus provide pluggable high-performance devices with improved signal integrity and system thermals, while lowering complexity of the printed circuit boards on which the connector is installed. Ultimately, embodiments of the apparatus enable the feature set of a computing system to be preserved or improved at a lower cost even as high-speed bus interfaces increase in speed. Improved signal integrity may be achieved with a direct high-speed cable to connector construction, enabling signals to run at desired higher speeds without multiple interconnections and the additional cost of carefully designed and expensive backplanes. The connector assembly or hybrid connector and high-speed cable may be implemented in a manner that avoids interference with airflow to enable optimized system cooling. The slower signals and power may be routed on a simple, low layer count horizontal printed circuit board. The connector assembly or hybrid connector may also provide a computing system with greater functionality, either in pluggable device density and/or better cooling for downstream components such as CPUs.

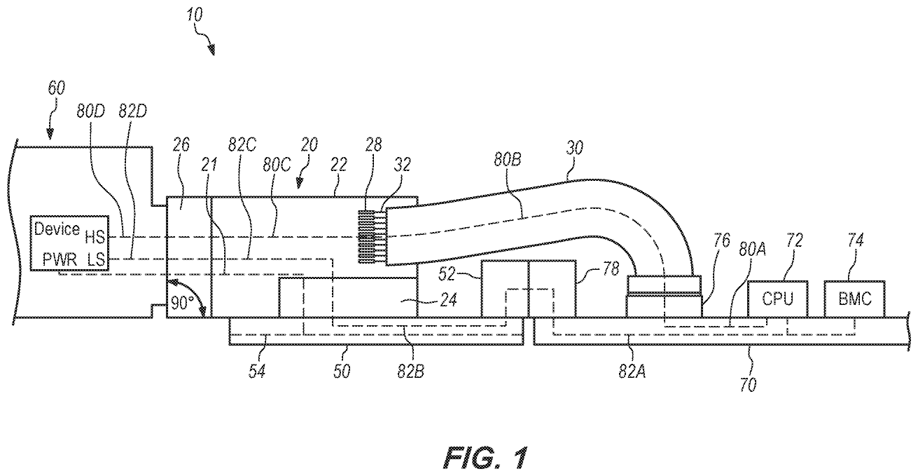

FIG. 1 is a side view of a computer system 10 including a connector assembly or hybrid connector 20 installed on a horizontal printed circuit board 50 to support communication with a pluggable printed circuit board 60. The computer system 10 further includes a system board 70 having a central processing unit (CPU) 72, a baseboard management controller (BMC) 74, a serial computer expansion bus connector 76, and a board-to-board connector 78. The horizontal printed circuit board 50 includes another board-to-board connector 52 for connecting to the board-to-board connector 78. Optionally, the board-to-board connectors 52, 78 may connect directly together as shown or with a cable therebetween (not shown).

The system board 70 may include various conductors, such as conductive traces, to form a high-speed bus 80A and a low-speed bus 82. For example, the high-speed bus 80 may be a Peripheral Component Interconnect Express (PCIe) bus and the low-speed bus 82 may be an Inter-Integrated Circuit (I2C) bus. The high-speed bus 80A may extend from the CPU 72 to the serial computer expansion bus connector 76, and the low-speed bus 82 may extend from either or both of the CPU 71 and BMC 74 to the board-to-board connector 78. Upon connecting the board-to-board connectors 52, 78, the low-speed bus 82 is extended to the horizontal printed circuit board 50, which may be referred to as a backplane. Both the horizontal printed circuit board 50 and the system board 70 may have a power plane and a ground plane, but only a power plane 54 is shown in the horizontal printed circuit board 50.

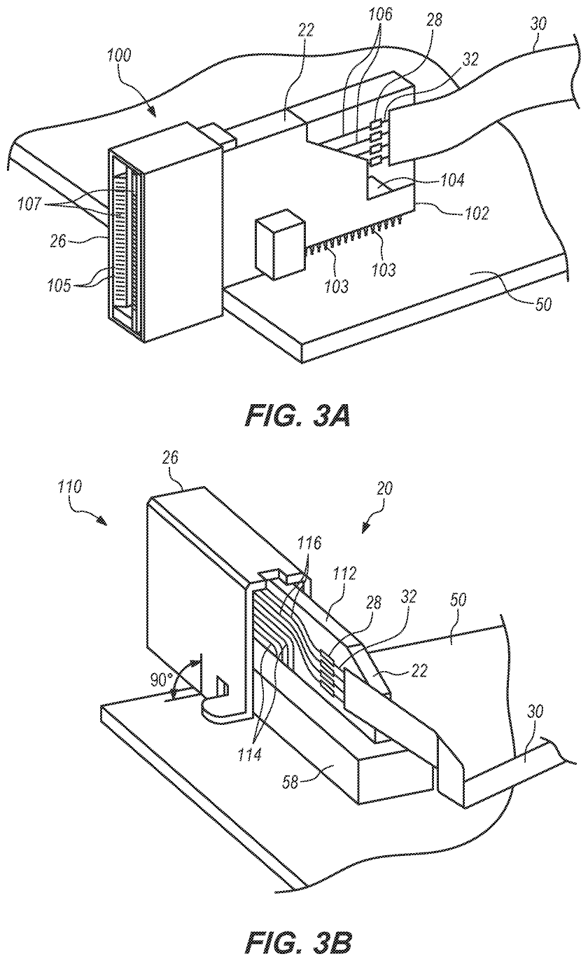

Communication between the system board 70 and the pluggable printed circuit board 60 (also referred to as a device card) is facilitated by the hybrid connector 20 installed on a horizontal printed circuit board 50. The connector assembly or hybrid connector 20 includes a connector body 22 including a first card edge connector 24 for connecting with the horizontal (first) printed circuit board 50, a second card edge connector 26, in the form of a card edge socket, for connecting with the pluggable (second) printed circuit board 60, and a wire termination including a set of conductive pads 28 directly connected to the ends of individual wires 32 of a high-speed communication cable 30. The second card edge connector 26 forms a right angle (see 90-degree angle in FIG. 1) with the first card edge connector 24, and the second card edge connector 26 is oriented to connect with the second printed circuit board 60 in an orthogonal orientation (see 90-degree angle in FIG. 3B) to the first printed circuit board 50.

A plurality of electronically conductive elements is supported by the connector body 22. Although any number of conductive elements may be provided on the connector body 22, the conductive elements may be include one or more conductive elements 21 for providing power from the horizontal printed circuit board 50 to the pluggable printed circuit board 60, one or more conductive elements 82C for providing low-speed communication signals from the horizontal printed circuit board 50 to the pluggable printed circuit board 60, and one or more conductive elements 80C for providing high-speed communication signals from the system board 70 to the pluggable printed circuit board 60.

More specifically, high-speed signals may be communicated from the CPU 72 to a device 62 on the pluggable printed circuit board 60 via the high-speed bus 80A on the system board 70, the high-speed wires 80B in the high-speed cable 30, and the high-speed conductive elements 80C on the hybrid connector 20 to the high-speed conductive elements 80D on the pluggable printed circuit board 60. The pathway 80A, 80B, 80C, 80D for the high-speed communication signals does not pass through the horizontal printed circuit board (backplane) 50.

The low-speed signals may be communicated from the CPU 72 and/or the BMC 74 to the device 62 on the pluggable printed circuit board 60 via the low-speed bus 82A on the system board 70, the low-speed conductive elements 82B in the horizontal printed circuit board (backplane) 50, and the low-speed conductive elements 82C on the hybrid connector 20 to the low-speed conductive elements 82D on the pluggable printed circuit board 60. Unlike the pathway 80A, 80B, 80C, 80D for the high-speed communication signals, the pathway 82A, 82B, 82C, 82D for the low-speed communication signals passes through the horizontal printed circuit board (backplane) 50. Along with other advantages describe herein, the construction of the horizontal printed circuit board (backplane) 50 may be substantially simplified because the board 50 does not need to support high-speed signaling. Accordingly, the horizontal printed circuit board 50 may be a simple, low-layer count printed circuit board, such as a 4-layer printed circuit board made with inexpensive materials that are suitable for low-speed signals, and does not require dense routing of impedance-controlled, high-speed signals as is typical of a device backplane that accommodates high-speed connections. Backplanes that include high-speed connections may be very thick and include up to 16+ layers.

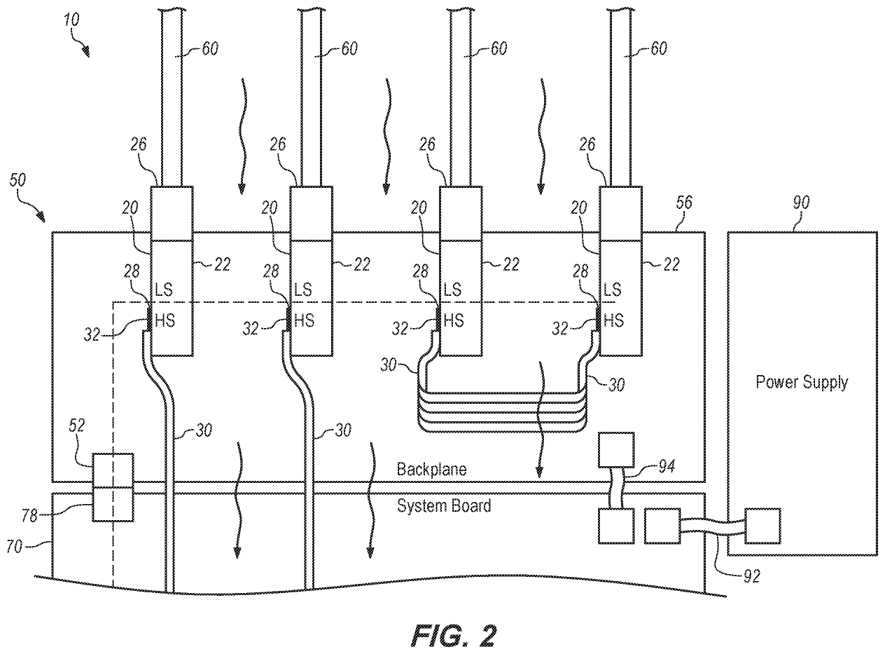

FIG. 2 is a top view of the horizontal printed circuit board 50 having multiple connector assemblies or hybrid connectors 20. Each of the hybrid connectors 20 has a connector body 22 including a first card edge connector (not shown; see connector 24 in FIG. 1) connected to the first printed circuit board 50 along a back edge 56 of the first printed circuit board, a card edge socket 26 for connecting with a device card 60, and a wire termination including the conductive pads 28 connected, such as by soldering, to the end of individual wires in a high-speed (HS) communication cable 30. Note that the card edge socket 26 is oriented to connect with the device card 60 in an orthogonal orientation to the first printed circuit board 50. Accordingly, the hybrid connectors 20 and the device cards 60 do not block airflow (see wavy arrows) through a chassis surrounding the system board 70, the backplane 50, and other components of the computer system 10. Furthermore, the two left-most high-speed cables 30 are illustrated as being connected to the wire terminations 28 of the two left-most hybrid connectors 20, which may be used to provide high-speed communication between each of the associated device cards 60 and the CPU 72 (See FIG. 1) on the system board 70. Another high-speed cable 30 is illustrated as being connected between the two right-most hybrid connectors 20, which may be used to provide high-speed communication between the two associated device cards 60 without sending the signals through the first printed circuit board 50.

Consistent with FIG. 1, the low-speed bus 82A on the system board 70 is coupled to the backplane 50 via the board-to-board connectors 78, 52 and further coupled to each of the hybrid connectors 20 via the first card edge connector (not shown; see connector 24 in FIG. 1) of each hybrid connector 20. The power plane 54 (see FIG. 1) and/or ground plane may extend across some or allow of the area of the horizontal printed circuit board 50, such that the first card edge connector (not shown; see connector 24 in FIG. 1) of each hybrid connector 20 may be coupled to the power plane and/or ground plane, such as through a compliant pin extending into a via in the board 50.

The computer system 10 may also include a power supply 90 that is coupled by a cable 92 to the system board 70. A separate cable 94 may provide power from the system board 70 to the backplane 50. Power supplied to the respective boards 70, 50 may be distributed to any or all of the components on those boards by a power plane with the boards. In one alternative, the cable 94 may be eliminated and power may be passed from the system board 70 to the backplane 50 through the board-to-board connectors 78, 52.

FIG. 3A is a perspective view of a first embodiment of the hybrid connector 100 that may be used as the hybrid connector 20 in FIGS. 1 and 2. The hybrid connector 100 has a lead frame 102 with compliant pins 103 for coupling to the horizontal printed circuit board 50. For example, the compliant pins 103 may be pressed into corresponding conductive vias or hole (not shown) that extend into the board 50 and into electronic communication with an intended conductive element, such as the conductive traces of a low-speed communication bus, a power plane, and/or a ground plane. Such connection between the compliant pins 103 and features of the board 50 may form a permanent connection.

The connector body 22 may be a rigid structure, such as a plastic, that positions the card edge socket 26 at a right angle to the lead frame 102. The connector body 22 may support a plurality of conductive wires 104 that extend from the individual pins 103 to individual pins 105 in the card edge socket 26. The connector body 22 may also support a plurality of conductive wires or traces 106 that extend from individual pads 28 of the wire terminations from individual wires 32 to individual pins 107 in the card edge socket 26. Accordingly, when a device card 60 is plugged into the card edge socket 26, the device card 60 may be coupled to both the wires 106 that are part of the high-speed bus (see bus 80C of FIG. 1) and the wires 104 that are part of the low-speed bus (see bus 82C of FIG. 1) or the power connections 21 (see FIG. 1).

FIG. 3B is a perspective view of a hybrid connector 110 that may be used as the hybrid connector 20 in FIGS. 1 and 2. The hybrid connector 110 may include a paddle card 112 that serves as the connector body. A plurality of conductive traces 114, 116 (only four shown) are formed on or in the paddle card 112. The conductive traces 114 may extend from a first portion of the pins in the card edge socket 26 to pads or fingers of a card edge connector pluggable into the card edge connector socket 58 on the backplane 50 to form electronic connections with the low-speed bus and the power conductors in the backplane 50. Conversely, the conductive traces 116 may extend from a second portion of the pins in the card edge socket 26 to the individual conductive pads 28 disposed on the paddle card 112 which are connected to the individual wires 32 of the high-speed cable 30 (see FIGS. 1 and 2).

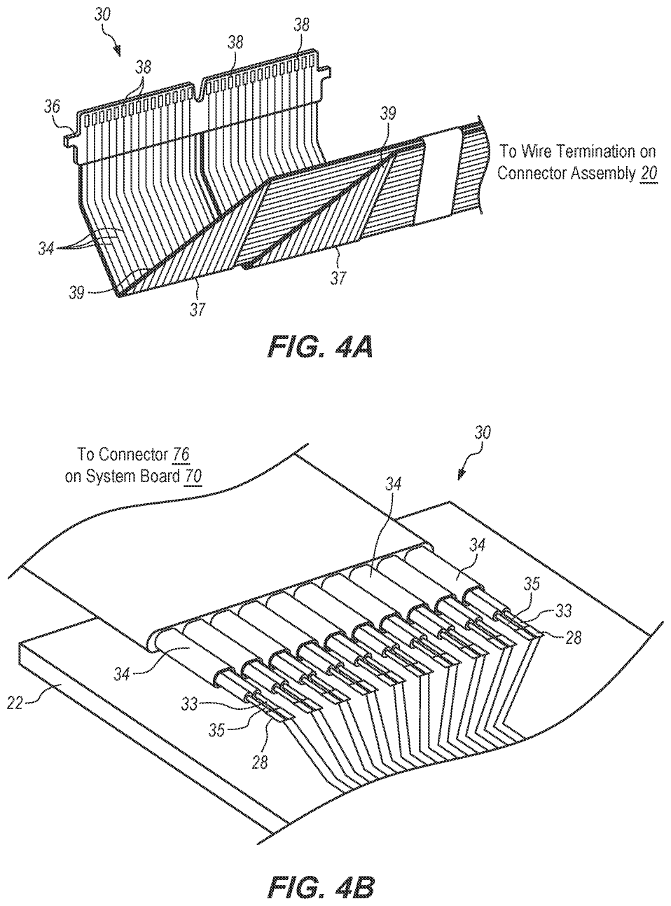

FIG. 4A is a diagram of one end of a high-speed cable 30. The high-speed cable 30 includes a plurality of wires or wire pairs 34, such as a plurality of twin-axial cables. As shown, the cable 30 forms a ribbon where ethe individual wires or wire pairs 34 are physically coupled side by side. Each pair or wires may be able to support differential signaling. The illustrated embodiment of the cable 30 forms a pluggable connection, such as a small paddle card 36 (printed circuit board) forming conductive pads or fingers 38 to which each wire of the high-speed cable is independently soldered. The cable paddle card may then be plugged into a card edge socket connector, such as the serial computer expansion bus connector 76 on the system board 70 (see FIG. 1) to form a connection there between.

The high-speed cable 30 has been bent or folded at points 37, 39 to follow a configuration that follows a desired route between two connectors. The materials of the cable or a coating on the outside of the cable may have sufficient plasticity to retain the bent or folded configuration. For example, the high-speed cable may be bent or folded to minimize airflow resistance, disturbance or redirection through a chassis that houses the printed circuit boards, connector assembly, cables and other components of the computer system. Specifically, if the high-speed cable is a ribbon cable or otherwise has a narrow dimension and a wide dimension, the interference with airflow may be minimized by bending or folding the cable so that the narrow dimension faces into the direction of airflow and the wide dimension extends along the direction airflow. Any number and type of folds may be used to accomplish a desired cable configuration. It is possible to bend or fold a cable to minimize airflow interference independent of the orientation or placement of the cable connector on the hybrid connector.

FIG. 4B is a schematic diagram illustrating the internal construction of a suitable high-speed cable 30 and a wire termination of the cable to the connector body 22. The high-speed cable 30 may include a plurality of wire pairs 34, such as a plurality of twin-axial cables. Each twin-axial cable 34 includes a pair of individually insulated wires 33, 35 that support differential signaling. Each of the wires 33, 35 may be individually soldered to the pads on the connector body 22 (see FIGS. 3A and 3B) and the opposing ends of the wires 33, 35 may be individually soldered to the pads 38 of the small paddle card 36 (see FIG. 4A).

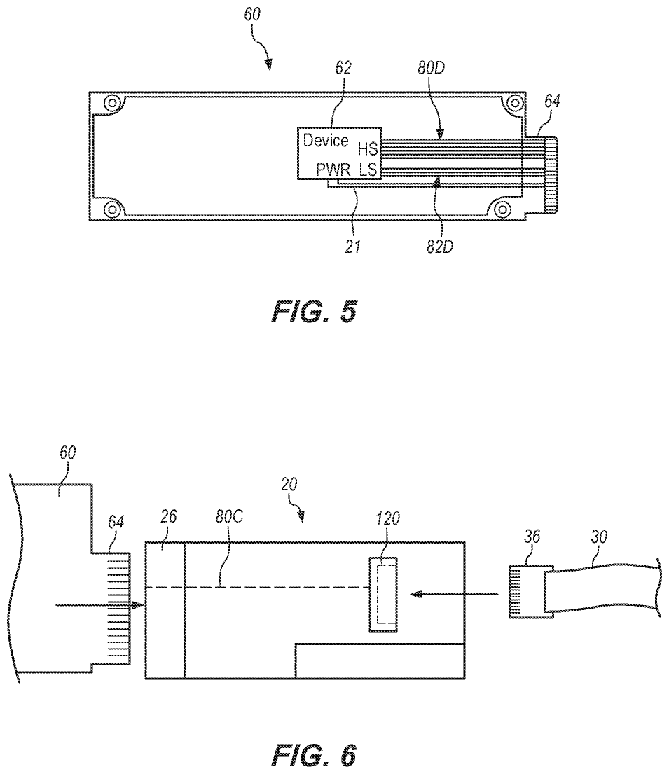

FIG. 5 is a side view of a pluggable printed circuit board 60 that may be connected to the card edge socket connector 26 of the hybrid connector 20. The pluggable printed circuit board 60 has a plurality of card edge fingers 64. One portion of the card edge fingers 64 are each connected to one of the high-speed conductive elements 80D leading to the device 62, such as an integrated circuit. Another portion of the card edge fingers 64 are each connected to one of the low-speed conductive elements 82D leading to the device 62 or some other device on the pluggable printed circuit board 60. Yet another portion of the card edge fingers 64 may be dedicated to providing power and/or ground connections 21 to the device 62. The second printed circuit board 60 may implement any of a wide variety of functionality, such as a graphics processing unit, non-volatile memory, network adapter, and other functions now in existence or developed in the future.

FIG. 6 is a schematic diagram of a connector assembly 20 including the having high-speed conductive elements 80C that terminate in a connector 120. The connector 120 may be various types of connectors, such as a card edge connector for receiving the card edge of the small paddle card 36 (see FIG. 4A). The use of the connector 120 is less preferred than a wire termination because it may introduce noise into the signals being carried over the cable 30.

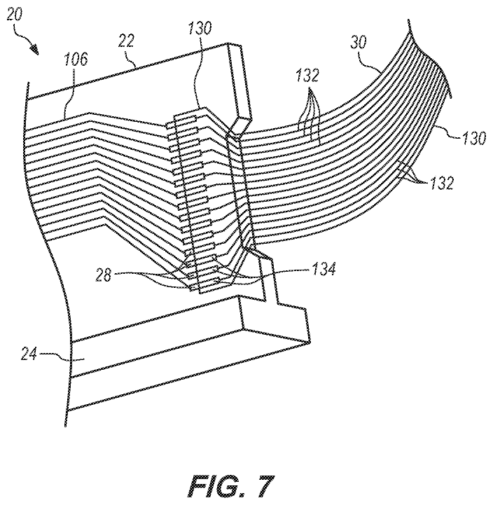

FIG. 7 is a diagram of a wire termination on the connector assembly 20 connected to a cable 30 in the form of a flex circuit. The cable 30 includes a plurality of conductors 132 form on a flexible plastic substrate material 130 that can be bent or twisting between the ends. Each of the conductors 132 may terminate in a conductive pad 134 along the end of the flex circuit. The conductive pads 134 may be positioned face-to-face with the conductive pads 28 formed on the connector body 22 and connected to the conductive wires or traces 106. Accordingly, the conductive pads 134 on the flex circuit may be soldered to the conductive pads 28 on the connector body 22 to form a high-speed connection that is both physically flexible and maintains a high signal integrity.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a connector assembly including a first card edge connector for connecting with a first printed circuit board, a second card edge connector for connecting with a second printed circuit board, and a wire termination connected to a first end of a high-speed communication cable, wherein the second card edge connector forms a right angle with the first card edge connector, and wherein the second card edge connector is oriented to connect with the second printed circuit board in an orthogonal orientation to the first printed circuit board; and
a plurality of electronically conductive elements supported by the connector assembly and having a first end terminating in the second card edge connector, wherein a first portion of the plurality of electronically conductive elements have a second end terminating in the wire termination, and wherein a second portion of the plurality of electronically conductive elements have a second end terminating in the first card edge connector.

2. The apparatus of claim 1, wherein the first portion of the plurality of electronically conductive elements carry high-speed signals and the second portion of the plurality of electronically conductive elements carry low-speed signals and electrical power.

3. The apparatus of claim 2, wherein the first portion of the plurality of electronically conductive elements include all of the lanes of a serial computer expansion bus.

4. The apparatus of claim 3, wherein the serial computer expansion bus supports communication using a Peripheral Component Interconnect Express standard.

5. The apparatus of claim 3, wherein the second portion of the plurality of electronically conductive elements includes an Inter Integrated Circuit bus for carrying the low-speed signals.

6. The apparatus of claim 5, wherein the low-speed signals are sideband signals selected from interrupts, power-management requests and/or reset commands.

7. The apparatus of claim 3, wherein the serial computer expansion bus supports a Compute Express Link standard.

8. The apparatus of claim 1, wherein the second card edge connector is a card edge socket for connecting with card edge fingers of the second printed circuit board.

9. The apparatus of claim 1, wherein the first card edge connector includes a direct lead frame attached to the first printed circuit board.

10. The apparatus of claim 9, wherein the lead frame includes compliant pins for connecting to plated through-holes in the first printed circuit board.

11. The apparatus of claim 9, wherein the lead frame include surface mount leads for soldering to conductive pads on the first printed circuit board.

12. The apparatus of claim 1, wherein the connector assembly includes a paddle card and the first card edge connector includes card edge fingers that are pluggable into a vertical card edge socket mounted on the first printed circuit board.

13. The apparatus of claim 1, wherein the high-speed communication cable includes at least 16 wires, and wherein the connector assembly includes at least 16 conductive elements extending from the wire termination to the second card edge connector.

14. The apparatus of claim 1, wherein the high-speed communication cable is a twin-axial, shielded cable.

15. The apparatus of claim 1, wherein the high-speed communication cable is capable of supporting up to 112 Gbps signaling.

16. The apparatus of claim 1, wherein the high-speed communication cable is a flex circuit.

17. The apparatus of claim 1, wherein the first printed circuit board is a backplane, and wherein a second end of the high-speed communication cable is connected to a serial computer expansion bus on a motherboard.

18. An apparatus, comprising:
a first printed circuit board;
a plurality of connector assemblies, each connector assembly including a first card edge connector connected to the first printed circuit board along an edge of the first printed circuit board, a card edge socket for connecting with a device card, and a wire termination connected to a high-speed communication cable, wherein the card edge socket forms a right angle with the first card edge connector and is oriented to connect with the device card in an orthogonal orientation to the first printed circuit board; and
each connector assembly including a plurality of electronically conductive elements that are supported by the connector assembly and have a first end terminating in the card edge socket, wherein, for each connector assembly, a first portion of the plurality of electronically conductive elements have a second end terminating in the wire termination, and wherein a second portion of the plurality of electronically conductive elements have a second end terminating in the first card edge connector.

19. The apparatus of claim 18, wherein the first printed circuit board is a horizontal backplane.

20. The apparatus of claim 18, wherein, for each connector assembly, the first portion of the plurality of electronically conductive elements include all of the lanes of a serial computer expansion bus to carry high-speed signals, and wherein, for each connector assembly, the second portion of the plurality of electronically conductive elements include an Inter Integrated Circuit bus to carry low-speed signals and conductive elements to carry electrical power.
